(19) United States
(12) Patent Application Publication
(10) Pub. No.: US 2015/0011106 A1
(43) Pub. Date: Jan. 8, 2015

(54) Lever Type Connector

(71) Applicant: YAZAKI CORPORATION, Tokyo (JP)

(72) Inventor: Jun Kamiya, Toyota-shi (JP)

(73) Assignee: YAZAKI CORPORATION, Tokyo (JP)

(21) Appl. No.: 14/492,147

(22) Filed: Sep. 22, 2014

Related U.S. Application Data
(63) Continuation of application No. PCT/JP2013/061557, filed on Apr. 12, 2013.

(30) Foreign Application Priority Data
Apr. 19, 2012 (JP) 2012-095806

(51) Int. Cl. H01R 13/629

(52) U.S. Cl. CPC H01R 13/62933
USPC 439/157

(57) ABSTRACT

After first and second connector housings have been aligned at an engagement initiating position, a lever is rotatably engaged with the first connector housing. The lever is provided with boss parts slidable in boss guiding grooves of the second connector housing and boss retracting grooves of the first connector housing. When the boss parts slide with rotation of the engagement operating lever, the connector housings move in an engaging direction such that the boss guiding grooves may be overlapped on the boss retracting grooves. By further rotating the lever, after the mutual engagement between the connector housings has been completed, the boss parts are released from the boss guiding grooves and the boss retracting grooves with the aid of slopes, thus enabling the lever to be detached from both the connector housings.

### CROSS REFERENCE TO RELATED APPLICATIONS

This application is a continuation of PCT application No. PCT/JP13/061557, which was filed on Apr. 12, 2013 based on Japanese Patent Application (No. 2012-095806) filed on Apr. 19, 2012, the contents of which are incorporated herein by reference.

### BACKGROUND OF THE INVENTION

1. Field of the Invention

The present invention relates to a lever type connector.

2. Description of the Related Art

FIG. 23 shows a conventional example of the lever type connector.

This lever type connector 100 is disclosed in the below mentioned, and includes a first connector housing 110, a second connector housing 120 which is engaged and connected with the first connector housing 110, and an engagement operating lever 130 which is rotatably mounted on the first connector housing 110.

The second connector housing 120 has an outer tubular wall part (a hood part) 121 into which the first connector housing 110 is inserted.

The engagement operating lever 130 is mounted on boss parts 111 which are formed so as to project from outer side faces of the first connector housing 110, as a lever member for reducing an operating force at a time of engaging operation and engagement releasing operation of the first connector housing 110 and the second connector housing 120.

As shown in the drawing, the engagement operating lever 130 includes a pair of lever bodies 131 which are opposed to each other so as to clamp a pair of the outer side faces of the first connector housing 110, a connecting member 132 interconnecting respective one ends of these lever bodies 131, rotation pivot holes 133 which are formed in the lever bodies 131 and adapted to be engaged with the boss parts 111 on the outer side faces of the first connector housing 110, and projected parts 134 as function points which are adapted to be engaged with lever locking holes 122 formed on outer side faces of the outer tubular wall part 121, at an engagement initiating time when the first connector housing 110 and the second connector housing 120 are aligned at an engagement initiating position.

In the example as shown in the drawing, the connecting member 132 functions also as a fulcrum for receiving the operating force, when the lever bodies 131 are rotated around the boss parts 111 as a rotation center.

In the lever type connector disclosed in, the first connector housing 110 and the second connector housing 120 are engaged and connected in the following steps.

As a first step, the engagement operating lever 130 is rotatably mounted on the first connector housing 110, as shown in the drawing. Then, a distal end part of the first connector housing 110 is inserted into the outer tubular wall part 121 of the second connector housing 120, as shown by an arrow mark X1 in the drawing. After the first connector housing 110 and the second connector housing 120 are aligned at the engagement initiating position, the projected parts 134 as the function point of the engagement operating lever 130 are engaged with the lever locking holes 122 of the second connector housing 120.

Thereafter, the connecting member 132 of the engagement operating lever 130 is pressed down thereby to rotate the engagement operating lever 130, as shown by an arrow mark R1 in the drawing. With this rotation movement of the engagement operating lever 130, the second connector housing 120 is drawn toward the first connector housing 110, and thus, the connector housings are brought into a mutually engaged state.

In order to release the mutual engagement between the connector housings, the connecting member 132 is rotated in an opposite direction to the direction of the arrow mark R1 in the drawing thereby to disengage the connector housings from each other.

### CITATION LIST

### Patent Literature

[PTL 1] Japanese Patent No. 3442661

However, in case of the lever type connector 100 disclosed in, the engagement operating lever 130 cannot be detached from the first connector housing 110, in a state where the connector housings are mutually engaged and connected.

Therefore, in case of the lever type connector 100 in, even in a state of actual use where the mutual engagement between the connector housings has been completed, a weight of the engagement operating lever 130 is added, which has been a factor for increasing a weight of the connector.

Moreover, in case of the lever type connector 100 in Patent Document 1, the lever type connector 100 must be necessarily equipped with the engagement operating lever 130. Therefore, there has been such a problem that the number of components is increased, which incurs an increase of cost.

### SUMMARY OF THE INVENTION

In view of the above, the invention has been made in order to solve the above described problem, and an object of the invention is to provide a lever type connector capable of realizing cost reduction by reducing the number of components, and weight reduction in a state of use.

In order to achieve the object described above, a lever type connector according to the invention is characterized by the following (1) to (4).

(1) A lever type connector comprising

a first connector housing,

a second connector housing which is engaged and connected with the first connector housing,

an engagement operating lever which is rotatably mounted on the first connector housing, wherein

the second connector housing includes

a pair of boss guiding grooves which are formed on a pair of outer side faces thereof extending in a direction perpendicular to an engaging direction of the first and second connector housings in such a manner that starting ends of the grooves are opened at respective one edges of the outer side faces, and

second boss releasing slopes which are formed at terminal ends of the boss guiding grooves so as to push out boss parts of the engagement operating lever from the boss guiding grooves to surfaces of the outer side faces, when the boss parts which have moved from the starting ends to terminal ends of the boss guiding grooves are pressed down in the engaging direction of the connector housings,

the first connector housing includes

an outer tubular wall part which is engaged with an outer periphery of the second connector housing,

a lever pivoting part which is provided at a back end side of an outer side face part of the first connector housing which is positioned close to the starting ends of the boss guiding grooves so as to be engaged with and disengaged from a pivot shaft part of the engagement operating lever, and adapted to rotatably support the pivot shaft part which is engaged,

boss retracting grooves which are formed on a pair of side walls of the outer tubular wall part at a predetermined inclination angle with respect to the engaging direction of the connector housings in such a manner that starting ends of the grooves are aligned with the starting ends of the boss guiding grooves, when the first connector housing and the second connector housing are aligned at the engagement initiating position, and terminal ends of the grooves are aligned with the terminal ends of the boss guiding grooves, when the engagement of the housings is completed, the boss parts which have passed the boss guiding grooves being allowed to slide in the boss retracting grooves, and

first boss releasing slopes which are formed at the terminal ends of the boss retracting grooves in a slanted shape extended from the second boss releasing slopes thereby to push out the boss parts which have been pushed out from the second boss releasing slopes to surfaces of the side walls,

the engagement operating lever includes

a pair of lever bodies which are opposed to each other so as to clamp outer faces of a pair of the side walls of the first connector housing in which the boss retracting grooves are formed,

the pivot shaft part which is provided at one end side of the lever bodies, and rotatably engaged with the lever pivoting part,

the boss parts which are projected from a pair of the lever bodies and allowed to slide in the boss guiding grooves and the boss retracting grooves,

the boss supporting grooves for positioning the boss parts at the starting ends of the boss guiding grooves and the boss retracting grooves which are overlapped, of the housings which are aligned at the engagement initiating position in an initial lever mounting state where the lever bodies having the pivot shaft part engaged with the lever pivoting part are uprightly erected on the lever pivoting part, the boss supporting grooves supporting the boss parts so as to move in a longitudinal direction of the lever bodies in such a manner that the boss parts move in the boss retracting grooves, when the lever bodies are rotated around the lever pivoting part, and

first boss urging springs for urging the boss parts so as to project from the boss supporting grooves, and allow the boss parts to be displaced into the retreated state, when the boss parts are pushed out by the second boss releasing slopes and the first boss releasing slopes, and

second boss urging springs for urging the boss parts in the boss supporting grooves toward the starting ends of the boss supporting grooves positioned close to the pivot shaft part,

wherein when the boss parts are moved along the second boss releasing slopes and the first boss releasing slopes with the rotating operation of the lever bodies, and released outward from the boss retracting grooves into the retreated state, the boss parts are returned to the starting ends of the boss supporting grooves by urging forces of the second boss urging springs, thereby enabling the engagement operating lever to be detached from the first connector housing.

(2) The lever type connector as set forth in the above (1), wherein

the boss supporting grooves are formed such that a depth of the grooves is set so that the boss parts can slide from the terminal ends to the starting ends of the grooves in a retreated state where the boss parts are released outward from the boss retracting grooves.

(3) The lever type connector as set forth in the above (1), wherein

the engagement operating lever functions as a lever member for reducing an operating force on occasion of engaging operation and engagement releasing operation between the first connector housing and the second connector housing.

(4) The lever type connector as set forth in the above (1), wherein

the pivot shaft part can be engaged with the lever pivoting part by being pressed with a larger force than predetermined along the engaging direction of the connector housings, and can be detached from the lever pivoting part by applying a larger extracting force than predetermined along the engaging direction of the connector housings.

According to the structure as described above in (1) to (4), the first connector housing and the second connector housing are aligned at the engagement initiating position, as a first step. Thereafter, by engaging the pivot shaft part of the engagement operating lever with the lever pivoting part of the first connector housing, the engagement operating lever is brought into a state rotatably connected to the first connector housing.

In the state where the connector housings are aligned at the engagement initiating position, as described above, the starting ends of the boss retracting grooves of the first connector housing and the starting ends of the boss guiding grooves of the second connector housing are aligned in position. Then, in the initial lever mounting state where the lever bodies having the pivot shaft part engaged with the lever pivoting part are uprightly erected on the lever pivoting part, the boss parts on the lever bodies are arranged at such positions that they can be inserted into the starting ends of the boss retracting grooves and the boss guiding grooves.

Accordingly, when the engagement operating lever is rotated from the initial lever mounting state, the boss parts on the lever bodies slide in the boss retracting grooves and the boss guiding grooves. Then, along with the sliding movements of the boss parts in the boss retracting grooves, the boss guiding grooves are drawn onto the boss retracting grooves, and thus, the mutual engagement between the connector housings proceeds. When the boss parts arrive at the terminal ends of the boss retracting grooves, the terminal ends of the boss retracting grooves and the terminal ends of the boss guiding grooves are overlapped, and thus, the mutual engagement between the connector housings is completed.

When the engagement operating lever is further rotated in the same direction from the state where the mutual engagement and connection between the connector housings has been completed, the boss parts slide along the second boss releasing slopes and the first boss releasing slopes, and consequently, the boss parts are respectively released from the boss retracting grooves and the boss guiding grooves to be brought into a retreated state where the boss parts are withdrawn toward the boss supporting grooves.

Then, the boss parts which have been displaced into the retreated state are returned to the starting ends of the boss supporting grooves by urging forces of the second boss urging springs. On this occasion, the engagement operating lever is returned to the initial lever mounting state where the pivot shaft part is rotatably locked to the lever pivoting part of the first connector housing. By applying a larger extracting force than predetermined to the engagement operating lever along the engaging direction of the connector housings, it is possible to detach the engagement operating lever from the first connector housing.

Specifically, according to the structure as described above in (1) to (4), after the mutual engagement and connection between the connector housings has been completed, the engagement operating lever is detached from the connector housings. In this manner, it is possible to realize weight reduction of the connector in a state of use.

Moreover, the engagement operating lever which has been detached from one lever type connector can be used for engaging operation of the other lever type connector. For this reason, as an ordinary component set of the lever type connector, only the first connector housing and the second connector housing may be contained in the set, excluding the engagement operating lever. In this manner, it is possible to realize cost reduction by decreasing the number of components.

According to the lever type connector of the invention, after the engagement and connection between the connector housings has been completed, the engagement operating lever is detached from the connector housings. In this manner, it is possible to realize weight reduction of the connector in a state of use.

Moreover, the engagement operating lever which has been detached from one lever type connector can be used for engaging operation of the other lever type connector. For this reason, as an ordinary component set of the lever type connector, only the first connector housing and the second connector housing may be contained in the set, excluding the engagement operating lever. In this manner, it is possible to realize cost reduction by decreasing the number of components.

The invention has been heretofore briefly described. Details of the invention will be further made clear, by reading through a mode for carrying out the invention (hereinafter referred to as “an embodiment”, which will be described below, referring to the attached drawings.

### BRIEF DESCRIPTION OF THE DRAWINGS

FIG. 1 is an exploded perspective view of a lever type connector in an embodiment according to the invention.

FIG. 2 is a side view of a second connector housing as shown in FIG. 1.

FIG. 3 is a plan view of a first connector housing as shown in FIG. 1.

FIG. 4 is a side view of the first connector housing as shown in FIG. 1.

FIG. 5 is a plan view of an engagement operating lever as shown in FIG. 1.

FIG. 6 is a sectional view taken along a line A-A in FIG. 5.

FIG. 7 is a sectional view taken along a line B-B in FIG. 6.

FIG. 8 is a perspective view of the engagement operating lever as shown in FIG. 5, showing arrangement of boss supporting grooves.

FIG. 9 is a plan view of the engagement operating lever showing an arrangement of boss urging springs for urging boss parts of the engagement operating lever toward starting ends of the boss supporting grooves.

FIG. 10 is a plan view of the engagement operating lever in a state where the boss urging springs are compressed with movements of the boss parts.

FIG. 11 is a perspective view of the connector in a state before the engagement operating lever is mounted on the first connector housing which is aligned with the second connector housing at an engagement initiating position.

FIG. 12 is a perspective view of the connector in an initial lever mounting state where a pivot shaft part of the engagement operating lever is engaged with a lever pivoting part of the first connector housing which is aligned with the second connector housing at the engagement initiating position.

FIG. 13 is a view as seen from a direction of an arrow mark C in FIG. 12.

FIG. 14 is a sectional view taken along a line D-D in FIG. 13.

FIG. 15 is a perspective view of the connector in a state where mutual engagement between the connector housings is completed, by rotating the engagement operating lever in a direction of an arrow mark R1 in FIG. 13.

FIG. 16 is a view as seen from a direction of an arrow mark E in FIG. 15.

FIG. 17 is a sectional view taken along a line F-F in FIG. 16.

FIG. 18 is a view as seen from an arrow mark J in FIG. 16, showing positions of the boss parts of the engagement operating lever, when the mutual engagement between the connector housings is completed.

FIG. 19 is a perspective view of the connector in a state where the boss parts of the engagement operating lever are released from boss guiding grooves and boss retracting groove, by further rotating the engagement operating lever in a direction of an arrow mark R2 from a state in FIG. 16.

FIG. 20 is a view as seen from a direction of an arrow mark G in FIG. 19.

FIG. 21 is an explanatory view of the connector in a state where the boss parts which have been released from the boss guiding grooves and the boss retracting grooves are returned to starting ends of the boss supporting grooves by urging forces of the second boss urging springs.

FIG. 22 is a view as seen from a direction of an arrow mark H in FIG. 21.

FIG. 23 is an exploded perspective view of a conventional lever type connector.

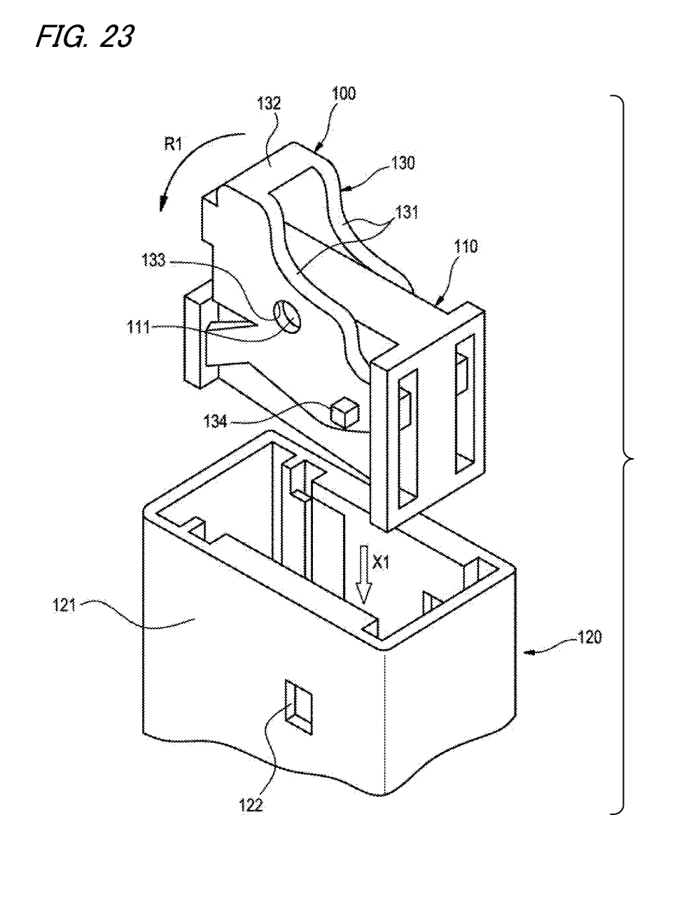

### DETAILED DESCRIPTION OF THE EXEMPLARY EMBODIMENTS

Now, a preferred embodiment of the lever type connector according to the invention will be described in detail, referring to the drawings.

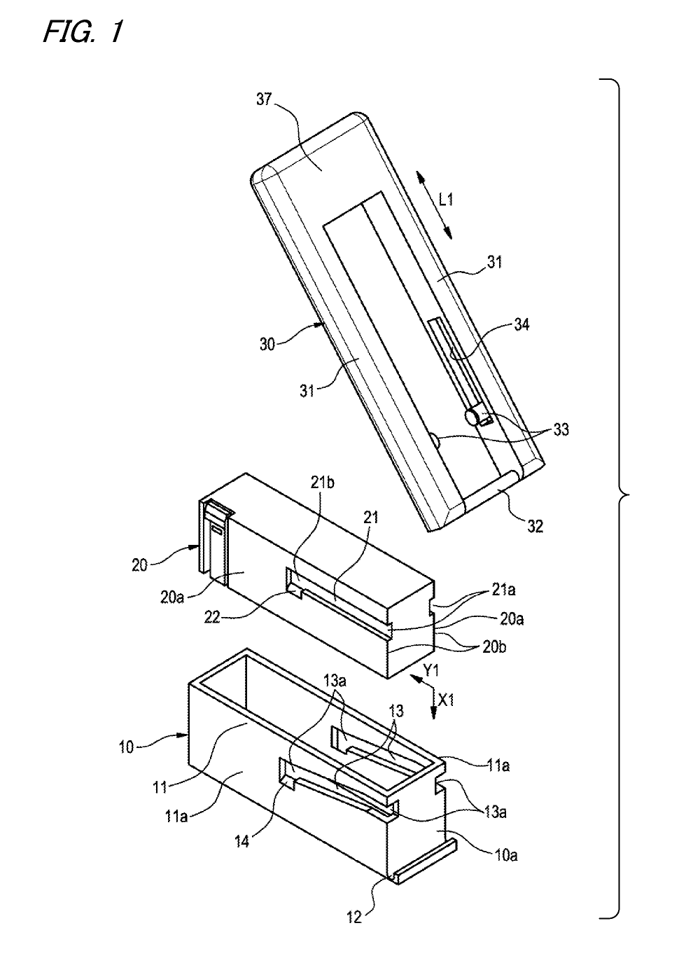

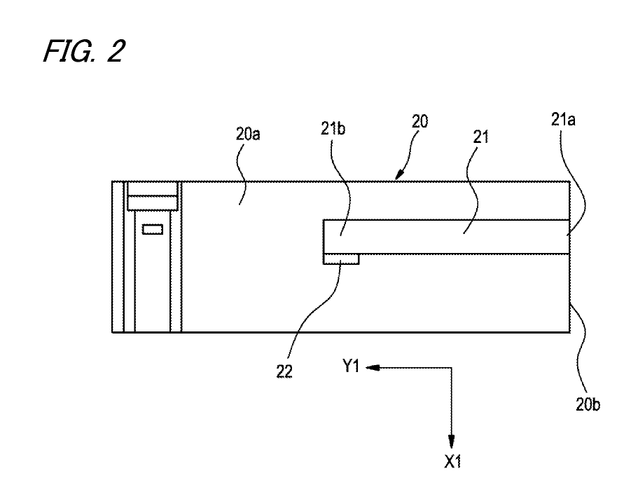

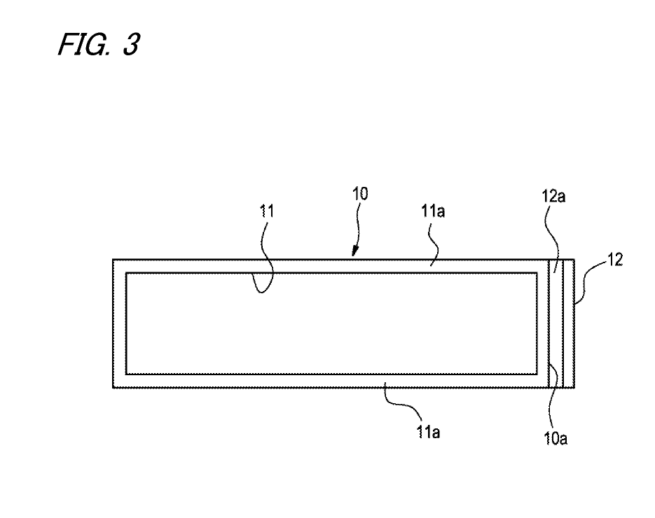

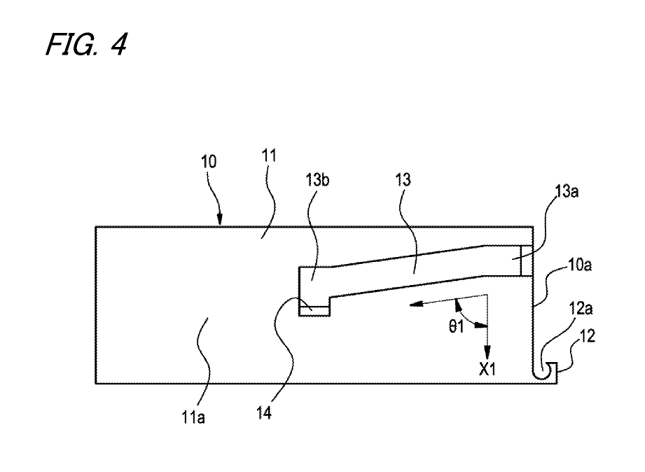

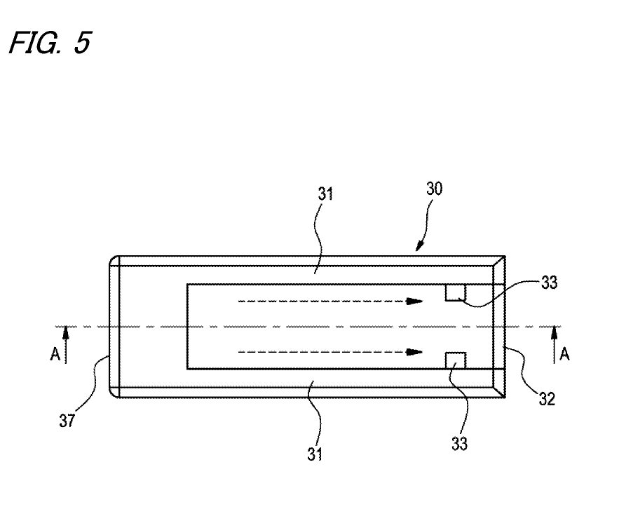

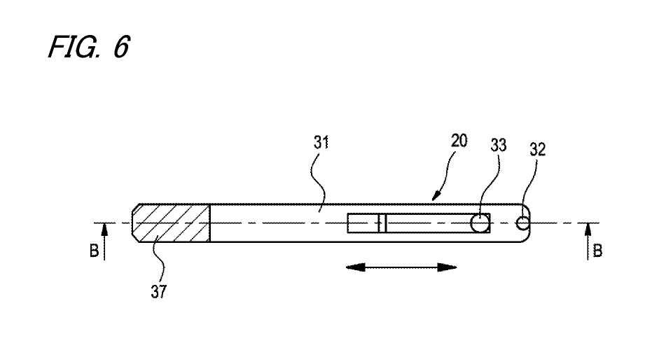

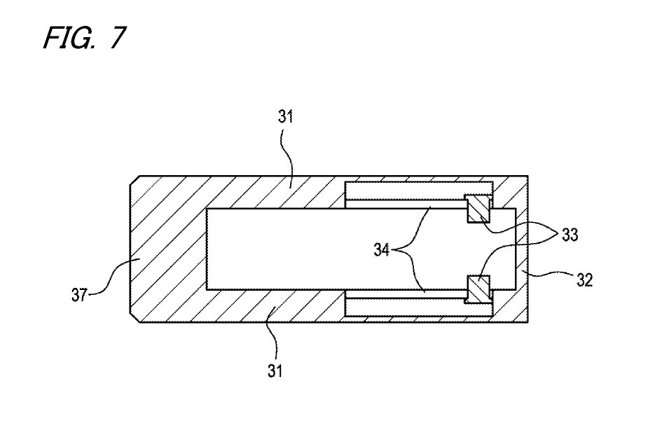

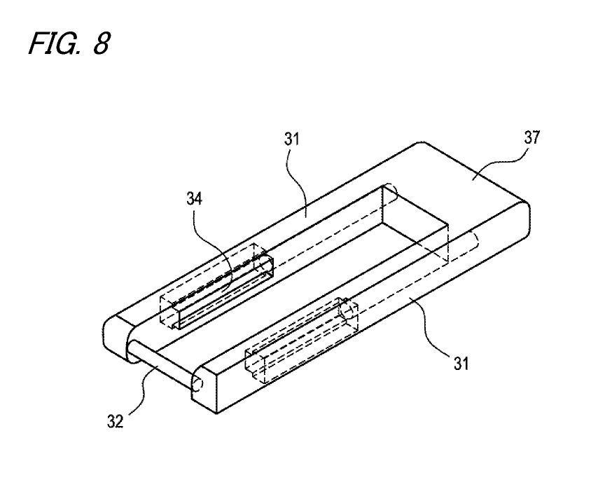

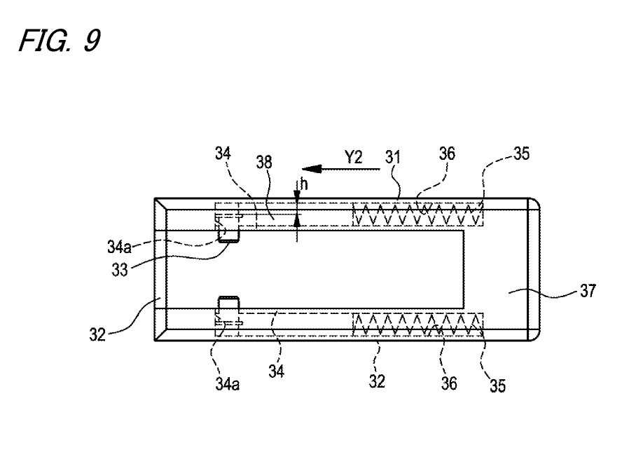

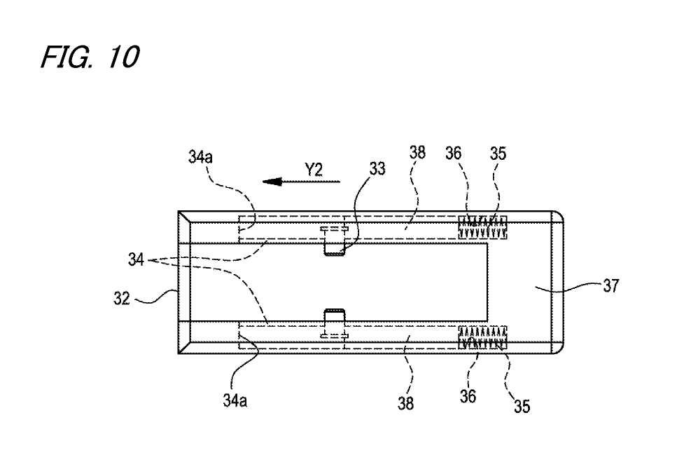

FIGS. 1 to 10 show the lever type connector in an embodiment according to the invention. FIG. 1 is an exploded perspective view of the lever type connector in the embodiment according to the invention, FIG. 2 is a side view of a second connector housing as shown in FIG. 1, FIG. 3 is a plan view of a first connector housing as shown in FIG. 1, FIG. 4 is a side view of the first connector housing as shown in FIG. 1, FIG. 5 is a plan view of an engagement operating lever as shown in FIG. 1, FIG. 6 is a sectional view taken along a line A-A in FIG. 5, FIG. 7 is a sectional view taken along a line B-B in FIG. 6, FIG. 8 is a perspective view of the engagement operating lever as shown in FIG. 5, showing arrangement of boss supporting grooves, FIG. 9 is a plan view of the engagement operating lever showing an arrangement of boss urging springs for urging boss parts of the engagement operating lever toward starting ends of the boss supporting grooves, and FIG. 10 is a plan view of the engagement operating lever in a state where the boss urging springs are compressed with movements of the boss parts.

A lever type connector 1 in this embodiment includes, as shown in FIG. 1, a first connector housing 10, a second connector housing 20 which is engaged and connected with the first connector housing 10, and an engagement operating lever 30 which is rotatably mounted on the first connector housing 10.

As shown in FIGS. 1 and 2, the second connector housing 20 has boss guiding grooves 21 and second boss releasing slopes 22 which are provided on a pair of outer side faces 20a.

The boss guiding grooves 21 are the grooves for enabling the boss parts 33 of the engaging operating lever 30, which will be described below, to slide therein, and extended along a rectilinear line in a direction (a direction of an arrow mark Y1 in FIGS. 1 and 2) perpendicular to an engaging direction of the connector housings 10 and 20 (a direction of an arrow mark X1 in FIGS. 1 and 2, which is hereinafter referred to as a housing engaging direction). Moreover, the boss guiding grooves 21 are formed in such a manner that starting ends 21a of the grooves are opened at respective one edges 20b of the outer side faces 20a.

The second boss releasing slopes 22 are formed at terminal ends 21b of the boss guiding grooves 21. These second boss releasing slopes 22 are so formed as to push out the boss parts 33 of the engaging operating lever 30 from the boss guiding grooves 21 to surfaces of the outer side faces 20a, when the boss parts 33 which have been displaced from the starting ends 21a to the terminal ends 21b of the boss guiding grooves 21 are pressed down in the direction of the arrow mark X1 in FIG. 1.

The first connector housing 10 includes, as shown in FIG. 1, an outer tubular wall part (a hood part) 11 in a rectangular tubular shape which is adapted to be engaged with an outer periphery of the second connector housing 20, a lever pivoting part 12, boss retracting grooves 13, and first boss releasing slopes 14.

The lever pivoting part 12 is a part for rotatably supporting a pivot shaft part 32 of the engaging operating lever 30, which will be described below. As shown in FIGS. 3 and 4, this lever pivoting part 12 is provided at a back end (a lower side in FIG. 4) of an outer side face part 10a of the first connector housing 10. The outer side face part 10a is one of four outer side faces of the first connector housing 10, and positioned at a side close to the starting ends 21a of the boss guiding grooves 21. As shown in FIG. 4, a part of the lever pivoting part 12 in a circumferential direction is opened thereby to form an open part 12a. This open part 12a is a gap into which the pivot shaft part 32 of the engagement operating lever 30 is to be inserted. By providing the open part 12a, the lever pivoting part 12 is formed in a substantially C-shape in section in which a part of its peripheral wall is opened.

When the pivot shaft part 32 is pressed against the open part 12a with a larger inserting force than predetermined along the housing engaging direction, the open part 12a is spread by elastic deformation of the lever pivoting part 12, thereby allowing the support shaft part 32 to be locked to or unlocked from the open part 12a.

The boss retracting grooves 13 are grooves for allowing the boss parts 33 of the engagement operating lever 30 which have passed the boss guiding grooves 21 to slide therein, and formed on a pair of side walls 11a of the outer tubular wall part 11. These boss retracting grooves 13 are formed in such a manner that their starting ends 13a are aligned with the starting ends 21a of the boss guiding grooves 21, when the first connector housing 10 and the second connector housing 20 are aligned at the engagement initiating position. Moreover, the boss retracting grooves 13 are formed in such a manner that their terminal ends 13b are aligned with the terminal ends 21b of the boss guiding grooves 21, when the mutual engagement between the connector housings is completed.

Each of the boss retracting grooves 13 is extended between the starting end 13a and the terminal end 13b at a predetermined inclination angle θ1 with respect to the housing engaging direction (the direction of the arrow mark X1 in FIG. 4).

As shown in FIGS. 1 and 4, the first boss releasing slope 14 is formed at the terminal end of the boss retracting groove 13. This first boss releasing slope 14 is formed in a slanted shape extended from the second boss releasing slope 22. Each of the boss parts 33 of the engagement operating lever 30 which has been pushed out from the second boss releasing slope 22 is pushed out toward the surface of the side wall 11a with the aid of this first boss releasing slope 14.

The engagement operating lever 30 is rotatably mounted on the first connector housing 10, as a lever member for reducing an operating force, on occasion of engaging operation and engagement releasing operation of the first connector housing 10 and the second connector housing 20.

As shown in FIG. 1 and FIGS. 5 to 10, the engagement operating lever 30 includes a pair of lever bodies 31, a pivot shaft part 32 which is provided at one end side of these lever bodies 31, the boss parts 33, the boss supporting grooves 34, and the boss urging springs 35. In this embodiment, the boss urging springs 35 function as first boss urging springs, and also as second boss urging springs in the invention.

A pair of the lever bodies 31 are opposed to each other so as to clamp a pair of the side walls 11a of the first connector housing 10 in which the boss retracting grooves 13 are formed. These lever bodies 31 are connected by the pivot shaft part 32 at their one ends, and connected, at the other ends, by a connecting member 37 which functions as an operating part on occasion of rotating operation.

As shown in FIG. 1, the pivot shaft part 32 has a shape of a round shaft. When this pivot shaft part 32 is pressed against the open part 12a the lever pivoting part 12 with a larger force than predetermined along the housing engaging direction, the pivot shaft part 32 can be rotatably engaged with the lever pivoting part 12. Moreover, the pivot shaft part 32 can be detached from the lever pivoting part 12, by applying a larger extracting force than predetermined to the open part 12a of the lever pivoting part 12 along the housing engaging direction.

The boss parts 33 are pin members which are projected from a pair of the lever bodies 31, and allowed to slide in the boss guiding grooves 21 and the boss retracting grooves 13.

The boss supporting grooves 34 are grooves for supporting the boss parts 33 so as to move in a longitudinal direction of the lever bodies 31 (a direction of an arrow mark L1 in FIG. 1).

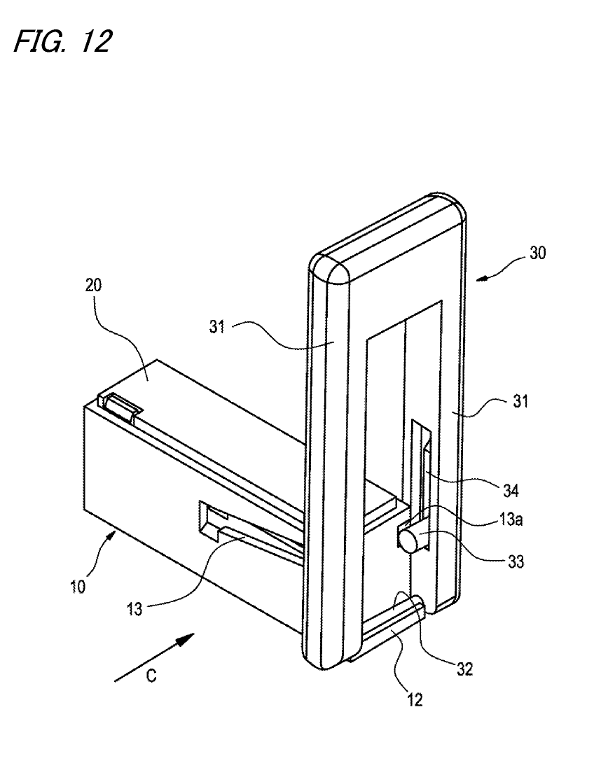

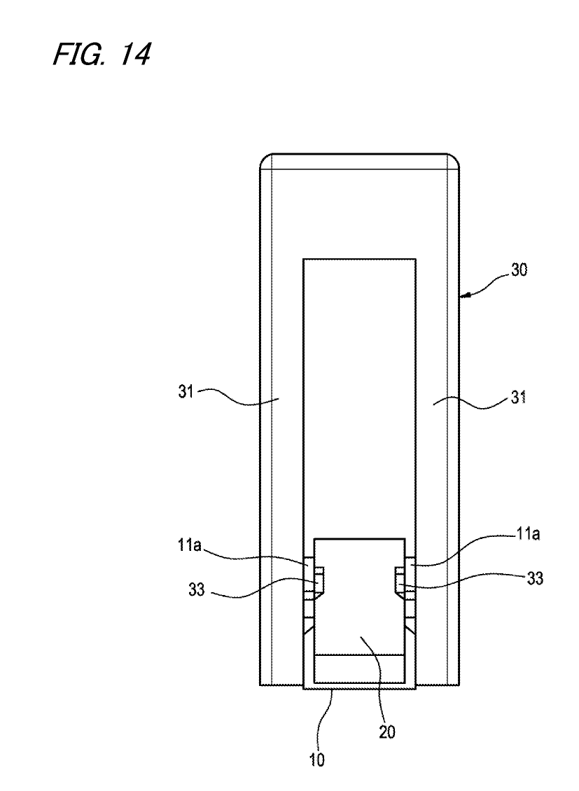

As shown in FIGS. 12 to 14, in an initial lever mounting state where the lever bodies 31 having the pivot shaft part 32 engaged with the lever pivoting part 12 are uprightly erected on the lever pivoting part 12, the boss parts 33 of the boss supporting grooves 34 are positioned at the starting ends 21a, 13a of the boss guiding grooves 21 and the boss retracting grooves 13 which are overlapped, of the two housings which are aligned at the engagement initiating position.

Moreover, the boss supporting grooves 34 support the boss parts 33 so as to move in the longitudinal direction of the lever bodies 31, in such a manner that when the lever bodies 31 are rotated around the lever pivoting part 12, the boss parts 33 move along the boss retracting grooves 13.

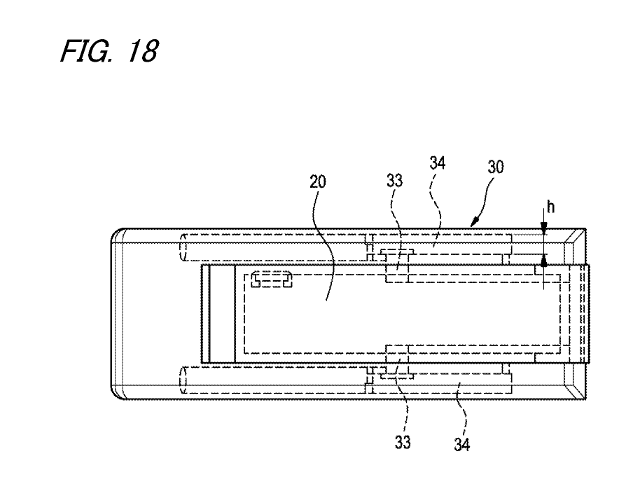

Further, in case of this embodiment, a depth h (See FIGS. 9 and 18) of the boss supporting grooves 34 is so set as to allow displacements of the boss parts 33, when the boss parts 33 are released outward from the boss retracting grooves 13 by pushing out functions of the first and second boss releasing slopes 14 and 22.

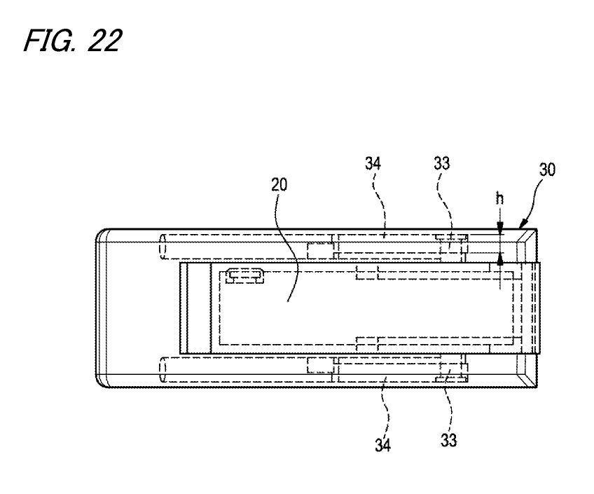

Moreover, the depth h of the boss supporting grooves 34 is set to be constant from the starting ends to the terminal ends of the grooves so that the boss parts 33 can slide from the starting ends to the terminal ends of the grooves in a retreated state where the boss parts 33 have been released outward from the boss retracting grooves 13, as shown in FIG. 22.

The boss urging springs 35 are compression springs which are contained in spring containing spaces 36 formed in the lever bodies 31, as shown in FIGS. 9 and 10. These boss urging springs 35 urge the boss parts 33 inside the boss supporting grooves 34 toward the starting ends 34a of the boss supporting grooves 34 (in a direction of an arrow mark Y2 in FIGS. 9 and 10) by way of relay rods 38 which are integral with the boss parts 33.

Herein, the starting ends 34a of the boss supporting grooves 34 mean the respective ends of the boss supporting grooves 34 which are positioned close to the pivot shaft part 32.

Each of the boss urging springs 35 is fixed to the relay rod 38, and therefore, the relay rod 38 can be inclined with respect to an axis of the boss urging spring 35 thereby to be displaced. When the relay rod 38 is inclined to be displaced, the boss part 33 can be displaced into the retreated state.

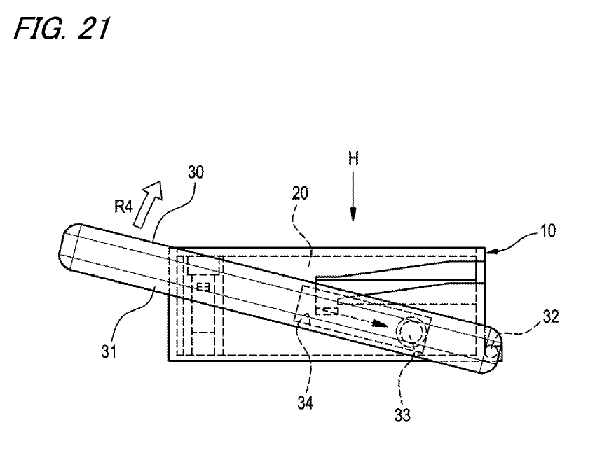

The boss urging springs 35 also function to return the boss parts 33 from the retreated state to an ordinary projected state, when the engagement operating lever 30 is detached from the first connector housing 10 by rotating the engagement operating lever 30 in a direction of an arrow mark R4 from a state in FIG. 21. Because the relay rods 38 which are inclined are restored in the same rectilinear line as the boss urging springs 35, the boss parts 33 in the retreated state are returned to the projected state.

It is to be noted that the first boss urging spring may be composed of a sliding plate which slides along a bottom face of the boss supporting groove 34, and a spring member which is provided between the sliding plate and the boss part 33 in a compressed state.

Moreover, it is also considered to incorporate the first boss urging spring in the boss part 33 itself.

The relay rod 38 is a member which slides in the boss supporting groove 34 following extension and contraction of the second boss urging spring 35.

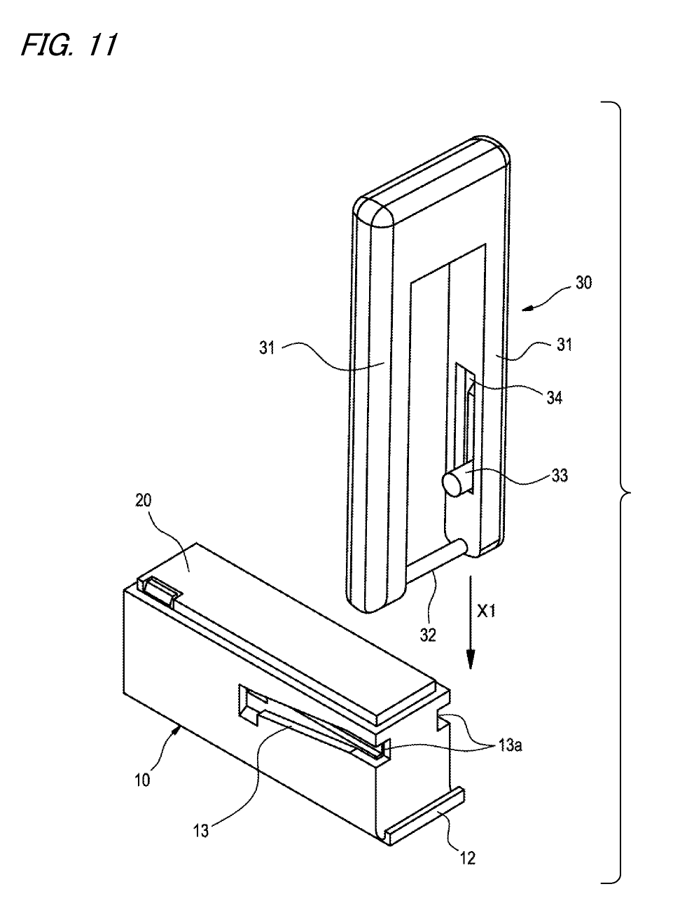

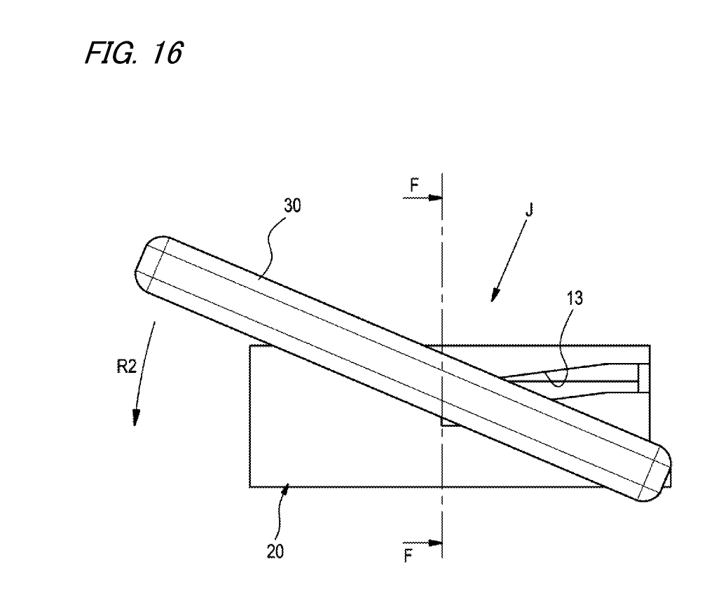

Then, a method of mutually engaging and connecting the connector housings 10 and 20 in the lever type connector 1 in the embodiment as described above, and a method of detaching the engagement operating lever 30, after the connector housings have been engaged and connected, will be described referring to FIGS. 11 to 22.

In case of the lever type connector 1 in this embodiment, the first connector housing 10 and the second connector housing 20 are aligned at the engagement initiating position, as a first step, as shown in FIG. 11. Thereafter, the pivot shaft part 32 of the engagement operating lever 30 is locked to the lever pivoting part 12 of the first connector housing 10, as shown in FIG. 12, thereby to bring the engagement operating lever 30 into a state rotatably connected to the first connector housing 10.

It is to be noted that in a state where the first connector housing 10 and the second connector housing 20 are aligned at the engagement initiating position, the starting ends 13a of the boss retracting grooves 13 of the first connector housing 10 and the starting ends 21a of the boss guiding grooves 21 of the second connector housing 20 are aligned in position.

In an initial lever mounting state where the lever bodies 31 having the pivot shaft part 32 engaged with the lever pivoting part 12 are uprightly erected on the lever pivoting part 12, as shown in FIGS. 12 to 14, the boss parts 33 on the lever bodies 31 are arranged at such positions that they can be inserted into the starting ends 13a, 21a of the boss retracting grooves 13 and the boss guiding grooves 21.

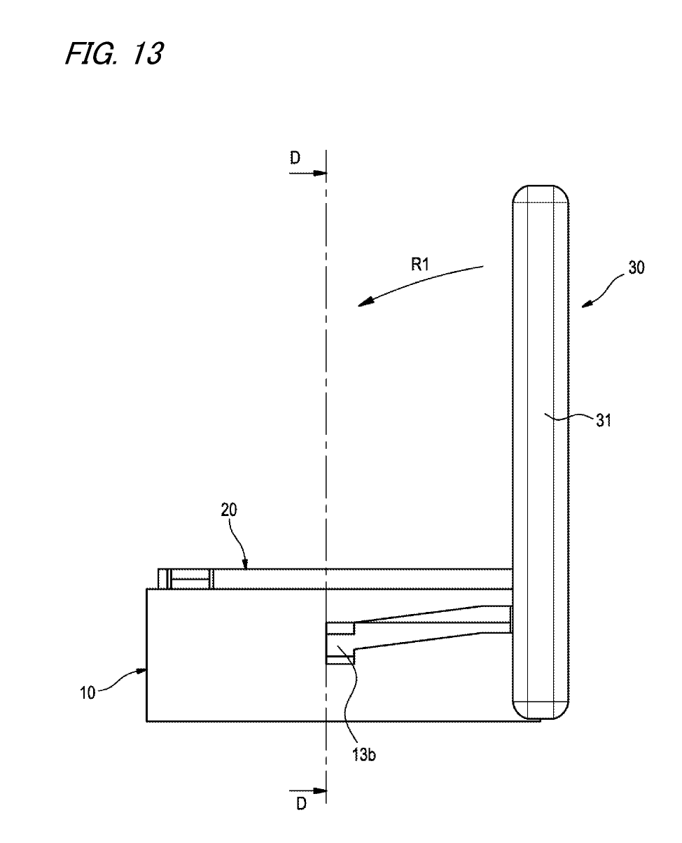

Accordingly, when the engagement operating lever 30 is rotated from the initial lever mounting state in a direction of an arrow mark R1 in FIG. 13, the boss parts 33 on the lever bodies 31 are slid in the boss retracting grooves 13 and the boss guiding grooves 21. Then, along with the sliding movements of the boss parts 33 inside the boss retracting grooves 13, the boss guiding grooves 21 are drawn onto the boss retracting grooves 13, and thus, the mutual engagement between the connector housings 10 and 20 proceeds.

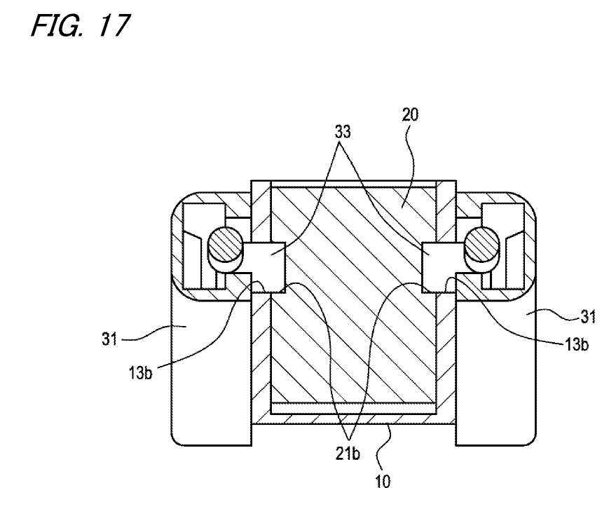

When the boss parts 33 have reached the terminal ends 13b of the boss retracting grooves 13, the terminal ends 13b of the boss retracting grooves 13 and the terminal ends 21b of the boss guiding grooves 21 are overlapped, as shown in FIG. 17, and the mutual engagement and connection between the connector housings 10 and 20 is completed.

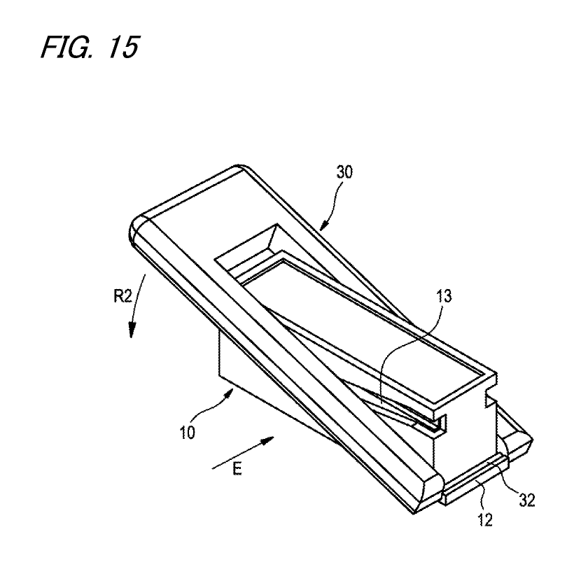

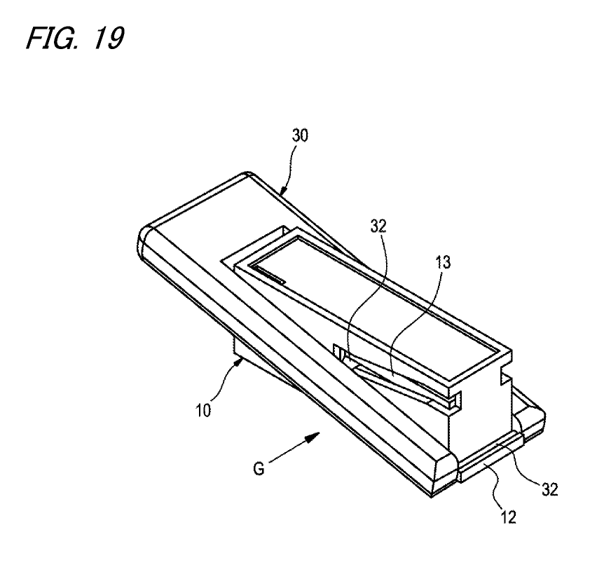

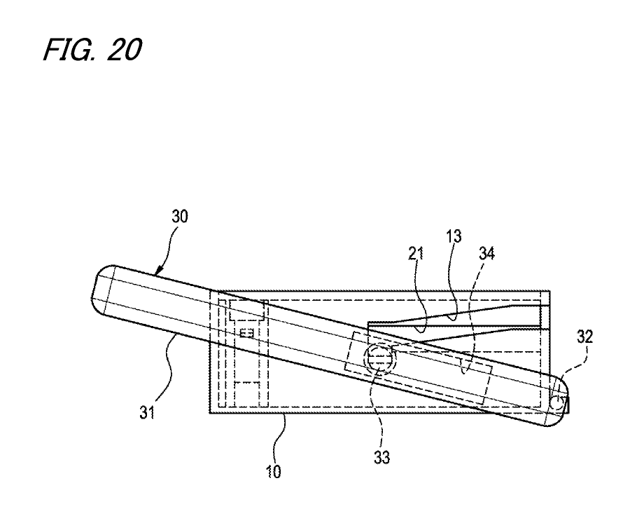

When the engagement operating lever 30 is further rotated in a direction of an arrow mark R2 in FIG. 15 from the state where the mutual engagement and connection between the connector housings 10 and 20 has been completed, the boss parts 33 slide along the second boss releasing slopes 22 and the first boss releasing slopes 14, as shown in FIGS. 19 and 20. In this manner, the boss parts 33 are released from the boss guiding grooves 21 and the boss retracting grooves 13 to be brought into the retreated state where the boss parts 33 are retreated to deep sides of the boss supporting grooves 34.

Then, the boss parts 33 which have been displaced into the retreated state are returned to the starting ends 34a of the boss supporting grooves 34 by the urging forces of the boss urging springs 35, as shown in FIG. 22. On this occasion, the engagement operating lever 30 is returned to the initial lever mounting state where the pivot shaft part 32 is rotatably locked to the lever pivoting part 12 of the first connector housing 10. By applying a larger extracting force than predetermined to the engagement operating lever 30 in the direction of the mutual engagement between the connector housings 10 and 20, it is possible to detach the engagement operating lever 30 from the first connector housing 10.

Specifically, in the lever type connector 1 in the above described embodiment, after the mutual engagement and connection between the connector housings 10 and 20 has been completed, the engagement operating lever 30 can be detached from the connector housings 10, 20. As the results, weight reduction of the connector in a state of use can be achieved.

Moreover, the engagement operating lever 30 which has been detached from one lever type connector can be used for engaging operation of the other lever type connector. For this reason, as an ordinary component set of the lever type connector, only the first connector housing 10 and the second connector housing 20 may be contained in the set, excluding the engagement operating lever 30. In this manner, it is possible to realize cost reduction by decreasing the number of components.

Further, in case of the lever type connector 1 in this embodiment, while the connector housings 10, 20 are on a halfway of the engagement, the boss parts 33 provided on the engagement operating lever 30 are engaged with the boss retracting grooves 13 of the first connector housing 10 and the boss guiding grooves 21 of the second connector housing 20. Therefore, the engagement operating lever 30 cannot be detached from these connector housings 10, 20.

Specifically, in the lever type connector 1 in this embodiment, in case where the engagement operating lever 30 cannot be detached from these connector housings 10, 20, after the engagement operating lever 30 is operated to rotate, it means that that the connector housings 10, 20 are on a halfway of the engagement (an incompletely engaged state). Therefore, by judging whether or not the engagement operating lever 30 can be detached, it is possible to determine the mutually engaged state of the connector housings 10, 20. In this manner, overlook of an incomplete engagement between the connector housings 10 and 20 can be prevented.

It is to be noted that the invention is not limited to the above described embodiment, but various modifications, improvements, and so on can be appropriately made. In addition, materials, shapes, sizes, numbers, positions to be arranged, etc. of the constituent elements in the above described embodiment are not limited, but optional, provided that the invention can be achieved.

The present invention is useful for providing a lever type connector capable of realizing cost reduction by reducing the number of components, and weight reduction in a state of use.

What is claimed is:

1. A lever type connector comprising
a first connector housing,
a second connector housing which is engaged and connected with the first connector housing,
an engagement operating lever which is rotatably mounted on the first connector housing, wherein
the second connector housing includes
a pair of boss guiding grooves which are formed on a pair of outer side faces thereof extending in a direction perpendicular to an engaging direction of the first and second connector housings in such a manner that starting ends of the grooves are opened at respective one edges of the outer side faces, and
second boss releasing slopes which are formed at terminal ends of the boss guiding grooves so as to push out boss parts of the engagement operating lever from the boss guiding grooves to surfaces of the outer side faces, when the boss parts which have moved from the starting ends to terminal ends of the boss guiding grooves are pressed down in the engaging direction of the connector housings,
the first connector housing includes
an outer tubular wall part which is engaged with an outer periphery of the second connector housing,
a lever pivoting part which is provided at a back end side of an outer side face part of the first connector housing which is positioned close to the starting ends of the boss guiding grooves so as to be engaged with and disengaged from a pivot shaft part of the engagement operating lever, and adapted to rotatably support the pivot shaft part which is engaged,
boss retracting grooves which are formed on a pair of side walls of the outer tubular wall part at a predetermined inclination angle with respect to the engaging direction of the connector housings in such a manner that starting ends of the grooves are aligned with the starting ends of the boss guiding grooves, when the first connector housing and the second connector housing are aligned at the engagement initiating position, and terminal ends of the grooves are aligned with the terminal ends of the boss guiding grooves, when the engagement of the housings is completed, the boss parts which have passed the boss guiding grooves being allowed to slide in the boss retracting grooves, and
first boss releasing slopes which are formed at the terminal ends of the boss retracting grooves in a slanted shape extended from the second boss releasing slopes thereby to push out the boss parts which have been pushed out from the second boss releasing slopes to surfaces of the side walls,
the engagement operating lever includes
a pair of lever bodies which are opposed to each other so as to clamp outer faces of a pair of the side walls of the first connector housing in which the boss retracting grooves are formed,
the pivot shaft part which is provided at one end side of the lever bodies, and rotatably engaged with the lever pivoting part,
the boss parts which are projected from a pair of the lever bodies and allowed to slide in the boss guiding grooves and the boss retracting grooves,
the boss supporting grooves for positioning the boss parts at the starting ends of the boss guiding grooves and the boss retracting grooves which are overlapped, of the housings which are aligned at the engagement initiating position in an initial lever mounting state where the lever bodies having the pivot shaft part engaged with the lever pivoting part are uprightly erected on the lever pivoting part, the boss supporting grooves supporting the boss parts so as to move in a longitudinal direction of the lever bodies in such a manner that the boss parts move in the boss retracting grooves, when the lever bodies are rotated around the lever pivoting part, and
first boss urging springs for urging the boss parts so as to project from the boss supporting grooves, and allow the boss parts to be displaced into the retreated state, when the boss parts are pushed out by the second boss releasing slopes and the first boss releasing slopes, and
second boss urging springs for urging the boss parts in the boss supporting grooves toward the starting ends of the boss supporting grooves positioned close to the pivot shaft part,
wherein when the boss parts are moved along the second boss releasing slopes and the first boss releasing slopes with the rotating operation of the lever bodies, and released outward from the boss retracting grooves into the retreated state, the boss parts are returned to the starting ends of the boss supporting grooves by urging forces of the second boss urging springs, thereby enabling the engagement operating lever to be detached from the first connector housing.

2. The lever type connector as set forth in claim 1, wherein
the boss supporting grooves are formed such that a depth of the grooves is set so that the boss parts can slide from the terminal ends to the starting ends of the grooves in a retreated state where the boss parts are released outward from the boss retracting grooves.

3. The lever type connector as set forth in claim 1, wherein
the engagement operating lever functions as a lever member for reducing an operating force on occasion of engaging operation and engagement releasing operation between the first connector housing and the second connector housing.

4. The lever type connector as set forth in claim 1, wherein
the pivot shaft part can be engaged with the lever pivoting part by being pressed with a larger force than predetermined along the engaging direction of the connector housings, and can be detached from the lever pivoting part by applying a larger extracting force than predetermined along the engaging direction of the connector housings.
